(19) United States
(12) Patent Application Publication
(10) Pub. No.: US 2023/0257083 A1
(43) Pub. Date: Aug. 17, 2023

(54) OFFSHORE STRUCTURE WITH CASTED JOINTS AND USE OF IT

(71) Applicant: STIESDAL OFFSHORE A/S, Give (DK)

(72) Inventor: Henrik Stiesdal, Odense C (DK)

(21) Appl. No.: 18/015,206

(22) PCT Filed: Jul. 8, 2021
(86) PCT No.: PCT/DK2021/050230

§ 371 Date: Jan. 9, 2023

(30) Foreign Application Priority Data
Jul. 8, 2020 (DK) PA 2020 70470

(51) Int. Cl. B63B 75/00; B63B 5/16; F03D 13/25

(52) U.S. Cl. CPC B63B 75/00; B63B 5/16; F03D 13/25; B63B 2035/446

(57) ABSTRACT

An offshore structure (1) with tubular braces (110) that are joined by joints (125) at nodes (120). The tubular braces (110) may be made of steel. The joint (125) is formed by means of casted concrete or grout in a receiving joint volume (150) in one or both of the braces (110). Also disclosed is a a keel structure formed by braces (110) and joints (125) as outlined and a combination of a wind turbine and such offshore structure (1).

### CROSS-REFERENCE TO RELATED APPLICATIONS

This application claims priority to PCT Application No. PCT/DK2021/050230, having a filing date of Jul. 8, 2021, which is based DK Application No. PA 2020 70470, having a filing date of Jul. 8, 2020, the entire contents all of which are hereby incorporated by reference.

### FIELD OF TECHNOLOGY

The following relates to a structure and its use, the structure comprising tubular braces joined at nodes by a joint. The joint is formed by casted concrete or grout in a receiving joint volume in the braces. The following also relates to an offshore structure, e.g., a keel structure, formed by braces and joints as outlined.

### BACKGROUND

Well-designed joints for large scale structures are of great importance. In particular, offshore structures, including keel structures for floating support structures, demand lasting joints under harsh conditions and generally experience large dynamical forces. Welding may impose margins on dimensioning as well as subsequent inspection or control.

Japanese patent application JP2000087504A discloses a method for providing an offshore tower structure, where ends of connecting tubes are inserted through openings into larger braces, and a grout cast is filling a portion of the larger brace and an end portion of the tube, which is provided with shear keys for additional stabilization.

US patent application US2015/0240442 discloses a gravity-based foundation system for an offshore wind turbine in which a tetrahedral frame of tubular braces is connected to concrete bases at the three nodes of the frame. The braces are cast into the concrete at the nodes, which implies that the amount of concrete is rather large, seeing that it must accommodate the ends of several braces. It would be desirable to provide a connection method that requires less concrete and gives more flexibility with respect to a further connection to buoyancy members.

### SUMMARY

An aspect relates to providing offshore structures which require less grout or concrete and give more flexibility with respect to a further connection to buoyancy members. Especially, it is an aspect to provide advantageous support structures for offshore wind turbines.

The aspects are achieved with a structure, for example offshore structure, as described in the claims.

An aspect is achieved by a structure comprising at least two tubular braces joined at a node by a joint. The tubular braces may be made of steel. The joint is formed by concrete cast or a grouted connection in a receiving joint volume in one or both of the braces.

In practical embodiments, the structure comprises at least three tubular braces arranged as a polygon, for example triangle, with end parts of the braces joined at nodes of the polygon by joints. Each joint is formed by a casting material, such as hardening polymer or concrete or grout in a receiving joint volume. Casting material and cast material is used interchangeably throughout this application.

In some embodiments, the receiving joint volume comprise a gap formed in one of the braces. The gap may be formed as a volume or space caused by different sized in otherwise complementary end parts. One brace may have a male part complementary to a female part in another brace except for an excess volume between the male and the female part.

In some practical embodiments, each node comprises a joint member different from the braces, and each end part has a receiving joint volume inside which a respective section of the joint member is received for connecting the end parts at the node by the joint member. After insertion of the joint member, for example a joint pipe, the volume between the joint member and the respective end part of the brace is filled with the fluidic casting material, in particular polymer, concrete, or grout, which is then hardened to provide the casting.

Thereby, a very strong and rigid connection is provided between the braces.

A further advantage is that otherwise required levels of tolerances may be overcome or eliminated and, thus, easing the construction or assembly process, seeing that the casting material fills the interspace irrespective of varying tolerances.

An even further advantage is obtained in that the joint type can be scaled relatively easily without involving further complications. Should there be a gap between capacity and load then this type of joint allows for immediate increase in e.g., diameter of a brace and/or increase in strength by selecting an appropriate class of concrete.

In fact, the disclosed joint type spares a bushing or sleeve and leaves complications to casting or filling of concrete.

The structure may be an offshore structure, in particular a support structure for an offshore wind turbine. The nodes may be arranged with a support or foot to be placed on ground or on the seabed. Alternatively, the structure is a floating structure.

Thereby, a very strong and rigid joint is provided connecting elongated members such as braces. The brace may be shaped tubular. Optionally, it has certain volumes with positive buoyancy. Thus, the joint as formed may be adjusted in weight to further provide the required positive buoyancy, ballast or negative buoyancy.

In an aspect, the joint comprises an end-part of a brace inserted into a receiving joint volume of another brace and the volume between is filled with concrete.

In an aspect, the joint is formed with end-parts of two or more braces, each configured with a receiving joint volume configured to receive a connecting joint member. The volume between the end-parts and the joint member is then filled with a casting material, such as grout or concrete.

In some embodiments, the joint member is straight and extends laterally through the end parts of a node. The cast material is then provided between an outer side of the joint member and an inner side of the end parts. Alternatively, the joint member has two opposite joint ends and is angled according to the angle required for insertion of the two joint ends into the end parts of the braces of the respective node, for example co-axial insertion.

The joint member may be a joint pipe being a solid member or a tubular member. Besides forming a strong and rigid joint, the joint member allows for provision of substantially identical braces that are connected or joined by the joint member.

In some embodiments, the structure comprises at least three tubular braces arranged as a polygon with end parts of the braces joined at the node and at further nodes of the polygon by the joint member.

In some embodiments, the polygon is an equilateral triangle with three braces forming the triangle, the three braces being joined by the joint member pairwise at the nodes.

In some embodiments, the structure comprises three tubular braces arranged as an equilateral triangle with end parts of the braces joined pairwise by the joints at the node and at two further nodes, wherein the joint member is straight and extends laterally through two adjacent end parts of a pair of braces at the node, wherein a central axis of the joint member has an angle of 60 degrees with the central axes of each of the two braces at the node, wherein the cast material is provided between an outer side of the joint member and an inner side of the end parts.

In some embodiments, adjacent end-parts at the node are formed complementary and abutting each other along an edge region, and wherein the straight joint member is inserted into the abutting complimentary brace end parts and joined to the brace end-parts by the casting material.

In an aspect, the end-part of the brace or joint member that is inserted into a receiving joint volume in a brace is fitted with an end flange have a flange portion that extends laterally outwards (L-flange) or both laterally inwards and outwards (T-flange). There may be an alternative or variation of the L- or T-like flange. There may be a V-end where the legs form an arrow and serves as a hook. Such end designs will make the joint even stronger, as it strengthens the axial stability for the inserted end-part or joint member. The flange may also be used for alignment during arrangement before and during filling of concrete.

In an aspect, the end-part of the brace that is inserted into a receiving joint volume in another brace or the joint end of the joint member that is inserted into an end-part of a respective brace is internally and/or externally for part of its length surrounded by multiple reinforcement bars.

Reinforcement bars allows for a flexible design, adjustment during alignment in connection with filling of concrete. At the same time, reinforcement allows for additional strength of the joint and may even form basis of reinforced concrete structures.

In an aspect, multiple reinforcement bars project further into the receiving joint volume than the brave or joint member itself

In an aspect, the end-part of the brace or joint member that is inserted into a receiving joint volume in a brace is internally and/or externally for part or its length fitted with a pre-cast bushing and/or or a sleeve comprising reinforced concrete.

In an aspect, the receiving joint volume comprises a tubular steel or concrete section that is generally coaxial with the end-part of the brace or joint member that is inserted into the receiving joint volume in a brace.

In an aspect, the end-part of the brace or member that is inserted into a receiving joint volume in a brace and/or the tubular steel or concrete section of the receiving joint volume is internally and/or externally for part or its length fitted with shear keys.

In an aspect, the joint is formed as a grouted joint by grouting cement. Such cement may be e.g., what is sold under the trade name BASF MasterFlow, which composition may form a starting point of grouting cement mixture.

In an aspect, the joint is formed as a cast joint by concrete, for example by mixing standard concrete based on Portland cement with suitable sea water ad-mixtures.

An aspect is achieved by a method of forming a structure of tubular braces joined at a node as outlined. The method comprises an act of joining two braces at the node. There is an act of filling of grouting cement and/or concrete into at least one of the braces at the node. This method provides a strong and rigid joint as outlined. The method is further advantageous since the acts can be performed on site and even subsea. The act of filling can be adjusted and controlled to provide a desired weight.

An aspect may be achieved by a keel structure with one or more nodes or joints formed as grouted joints as outlined. The keel structure may be formed by substantially identical linear braces arranged to form a polygon, e.g., a triangle, and wherein each brace has negative buoyancy.

An aspect is achieved by a method of forming a keel structure as outlined and according to the acts described. The act of filling or casting is performed to balance the buoyancy of the keel structure to predetermined balanced buoyancy

In the following, further aspects of the outlined joints will be elaborated upon. In particular the outlined aspects relate to structure with multiple joints and where the structure is with overall properties such as rigidity as a single body. The structure may be for an offshore structure, optionally floating structure, such as a keel structure for a floating off-shore platform, in particular for an offshore wind turbine. To form such single body, the structure may comprise at least two braces that are joined at a node by a joint. The joint may be as previously outlined where the joint is formed by concrete or cement grout in a receiving joint volume in one of the braces.

It is understood that the receiving joint volume may comprise a gap formed in one of the braces. The gap may be formed as a volume or space caused by different sized in otherwise complementary end parts. One brace may have a male part complementary to a female part in another brace except for an excess volume between the male and the female part.

In an aspect, the structure is an offshore structure. The structure may be a floating structure having positive buoyancy. The structure may be a sinking structure having negative buoyancy. The structure may be a keel for an offshore structure.

The braces may be longitudinal or linear in shape and the joints forming nodes. The brace may have end-parts that are configured for establishing a joint. Between or at ends of a brace, the brace may be configured with tanks or structures to establish a predetermined level of buoyancy or even to adjust buoyancy.

Thus, it is possible to establish an offshore structure with positive, negative, variable or adjustable buoyancy.

In an aspect, the structure is formed by substantially identical and linear braces. The linear braces may be arranged to form a polygon, such as a triangle. According to the desired shape, the end parts of braces may be adapted or pre-configured with required angles to form a single structure. For an equilateral triangle, the angle between braces at a joint or node is 60 degrees.

The braces may be joined by casting, for example grouting. Thereby is achieved a substantially rigid single body in a simple way. Especially, the nodes may be particularly rigid, and during operation, the node points of the structure may behave identically whilst the braces may flex or deform between node points.

The braces may be of steel and the joints formed by grouting concrete to make the bond between braces.

As an example, a keel structure may be suspended at node points and with weight of 100 tons to several hundred tons of the keel structure.

Furthermore, the grouting may be part of the ballasting of the structure. In example a keel structure for a floating structure. The joints may be formed onshore, and the keel structure may have buoyancy suitable for transport or even a positive buoyancy enabling a floating structure. The braces may be configured to receive a cement mixture to completely adjust the level of ballast.

For example, such keel structure may be formed by braces having a diameter in the range of 1 meter to 6 meters, such as 2 meters. Brace ends may be joined in areas where the length or extent of the receiving volume is in the range of 3 meters to 5 meters. In the case of 3 meters, the forces to be transferred are about 3,000 kN radially and axially.

Such structure will have a surface area of about 6 m² radially and 20 m² axially. The resulting tensions are in the order of 0.5 MPa radially and 0.15 MPa axially. As an example, standard concrete 35M (35 Mpa) may transfer 20 MPa radially and 5 MPa axially.

In example such keel structure may be formed by braces having a diameter of about 2,000 mm. Brace ends may be joined in areas where the length or extend of the receiving volume is about 3,000 to 5,000 mm. In the case of 3,000 mm the forces to be transferred are about 3,000 kN radially and axially.

Such structure will have a surface area of about 6,000,000 mm2 radially and 20,000,000 mm2 axially. The resulting tensions are in the order of 0.5 MPa radially and 0.15 MPa axially. As an example, standard concrete 35M (35 Mpa) may transfer 20 MPa radially and 5 MPa axially.

In an aspect, the joint comprises a thin end-part of a brace inserted into a receiving joint volume of another brace having a thick end-part and a through end-part of the another brace, and the receiving joint volume between is filled with the concrete.

In another example a keel structure may be formed by three braces with a diameter of about 4 meters and a length of 65 meters.

In another example a keel structure may be formed by three braces with a diameter of about 4,000 mm and a length of 65,000 mm.

In an aspect, a joint in the offshore structure or keel structure is formed of brace end-parts of two braces, each configured with a receiving joint volume. The thicker part or through part of a brace is configured to receive a joint pipe or joint member and the receiving joint volumes between is filled with the concrete.

The offshore structure or keel structure may have the respective brace end-parts formed complementary to interface against each other.

In an aspect, the joint pipe or joint member is an angled, optionally bent, joint pipe and with joint ends inserted into the receiving joint volume at the very end of respective braces.

The joint ends of the joint member are positioned co-axial with the corresponding end-parts of the brace.

The bent joint pipe may be U-shaped or V-shaped otherwise angled according to the shape of the structure. The angled joint member may be shaped as a piecewise linear type. The shape might be boomerang shaped.

In an aspect, a single piece, e.g., monolith, joint pipe or cylindrically shaped joint member material is heated, optionally piecewise, and under temperature control during bending. The angles may be from above 0 and to 180 degrees and of diameters or variable diameters between 10 to 100-200 cm.

The reinforcement bars may be steel reinforcements that extend fully or partially into another brace.

In an aspect, the brace end of one brace is inserted into a receiving joint volume of another brace and comprises multiple reinforcement bars that at least partially enters the receiving joint volume.

In an embodiment, an end of the brace is a thin end-part of the brace that is extended with reinforcement bars that extends into a receiving joint volume of a thick end-part of another brace.

The reinforcement bars may be arranged in the periphery of the thin end-part of the brace. There may be more layers or arrays of reinforcement bars.

As such, the offshore structure, for example keel structure, may have one or more joints formed as grouted joints.

An advantage is achieved by forming an offshore structure, for ample keel structure, where braces are joined at one or more nodes as outlined. There is an act of joining two braces at a node. There is an act of filling of concrete into a receiving joint volume of least one of the braces at the node.

The forming may be of multiple braces and multiple nodes and the act of filling or casting is performed to balance the buoyancy of the structure. The filling may be per-formed onshore to provide a structure with suitable ballast for transportation also at sea.

### ASPECTS

In the following, a number of interrelated aspects are presented, which can be combined with the other aspects described herein.

Aspect 1. A structure comprising at least two tubular braces joined at a node by a joint, wherein the tubular braces are made of steel, and wherein the joint is formed by concrete cast or grouted in a receiving joint volume in one or both of the braces.

Aspect 2. The structure according to aspect 1, wherein the structure is an offshore structure.

Aspect 3. The structure according to any one or more of the preceding aspects, wherein the joint comprises an end-part of a brace inserted into a receiving joint volume of another brace, and where the volume between is filled with concrete.

Aspect 4. The structure according to any one or more of the preceding aspects, wherein the joint is formed of end parts of two or more braces each configured with a receiving joint volume configured to receive a joint member, and where the volume between the end parts and the member is filled with concrete.

Aspect 5. The structure according to any one or more of the preceding aspects, wherein the end-part of the brace or member that is inserted into a receiving joint volume in another brace is fitted with at least one L- or T-flange.

Aspect 6. The structure according to any one or more of the preceding aspects, wherein the end-part of the brace or member that is inserted into a receiving joint volume in another brace is internally and/or externally for part or its length surrounded by multiple reinforcement bars.

Aspect 7. The structure according to aspect 6, wherein the multiple reinforcement bars project further than the end-part of the brace or member into the receiving joint volume in the other brace.

Aspect 8. The structure according to any one or more of the preceding aspects, wherein the end-part of the brace or member that is inserted into a receiving joint volume in another brace is internally and/or externally for part or its length fitted with a pre-cast bushing and/or sleeve comprising reinforced concrete.

Aspect 9. The structure according to any one or more of the preceding aspects, wherein the receiving joint volume comprises a tubular steel or concrete section that is generally coaxial with the end-part of the brace or member that is inserted into the receiving joint volume in another brace.

Aspect 10. The structure according to any one or more of the preceding aspects, wherein the end-part of the brace or member that is inserted into a receiving joint volume in another brace and/or the tubular steel or concrete section of the receiving joint volume is internally and/or externally for part or its length fitted with shear keys.

Aspect 11. The structure according to any one or more of the preceding aspects, wherein the joint is formed as a grouted joint by grouting cement, e.g., BASF MasterFlow.

Aspect 12. The structure according to any one or more of the preceding aspects, wherein the joint is formed as a cast joint by concrete, e.g., standard concrete based on Portland cement with suitable sea water admixtures.

Aspect 13. Method of forming a structure of tubular braces joined at a node according to any one or more of aspects 1 to 12, the method comprising acts of
joining two braces at the node;
filling of grouting cement and/or concrete into at least one of the braces at the node.

Aspect 14. A keel structure according to any one or more of aspects 1 to 12, wherein the keel structure is formed by substantially identical and linear braces arranged to form a polygon; e.g., a triangle and wherein each brace has negative buoyancy.

Aspect 15. A method of forming a keel structure according to aspect 14 and according to the method of aspect 13 and wherein the act of filling is performed to balance the buoyancy of the keel structure to predetermined balanced buoyancy.

### BRIEF DESCRIPTION

Some of the embodiments will be described in detail, with references to the following Figures, wherein like designations denote like members, wherein:

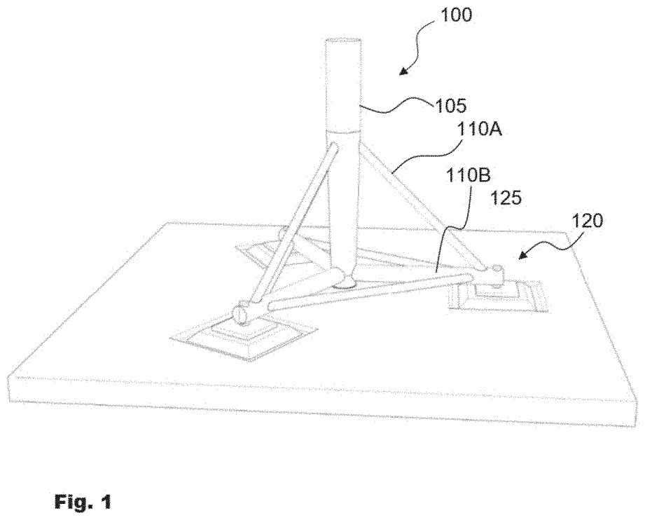

FIG. 1 illustrates a structure with a grouted joint at a node;

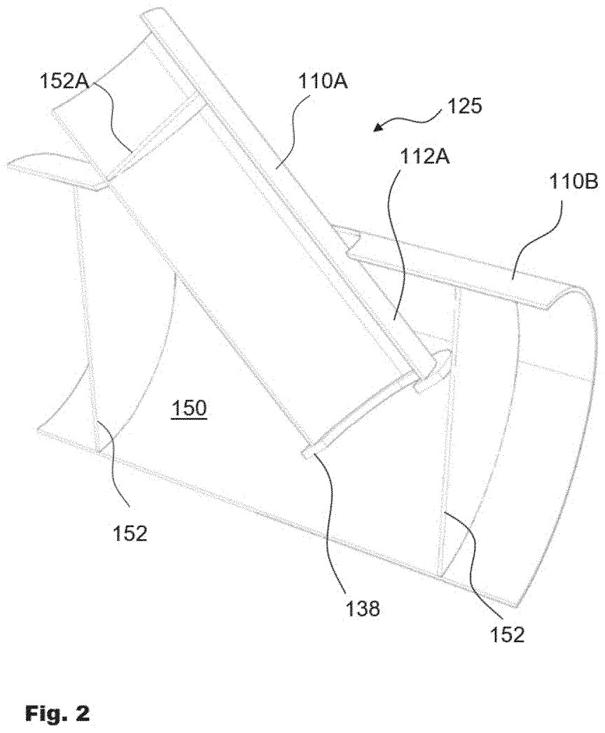

FIG. 2 illustrates a brace inserted into a receiving volume of another brace;

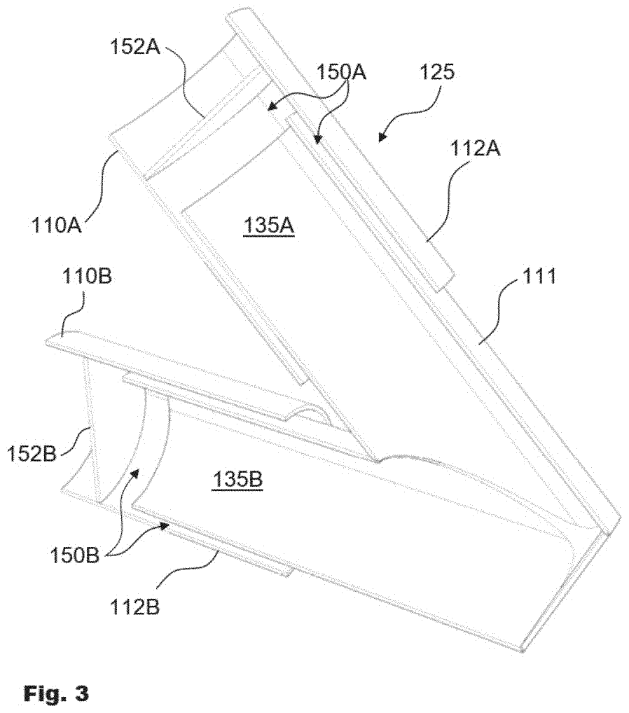

FIG. 3 illustrates a joint member inserted into a receiving volume of respective braces;

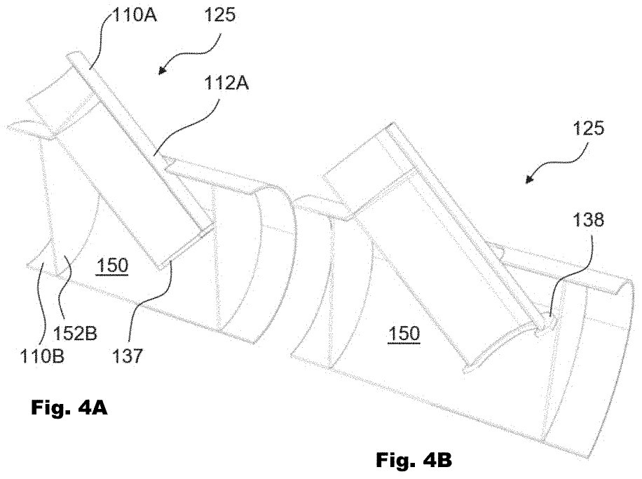

FIG. 4A illustrates aspects of brace end fittings;

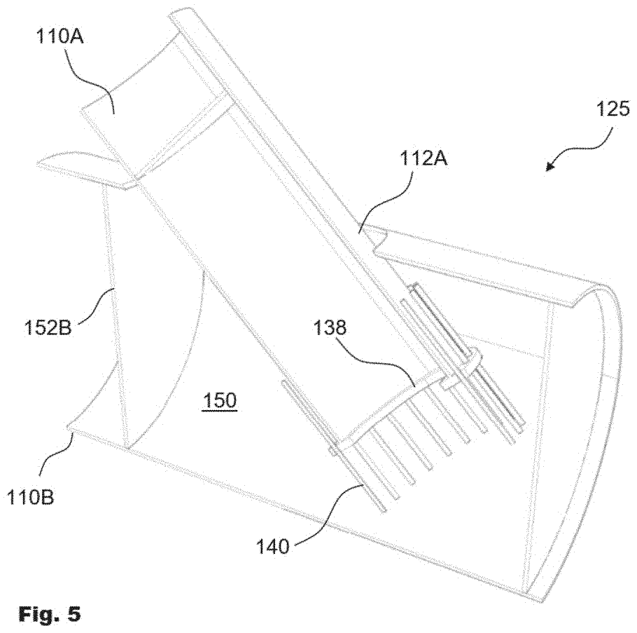

FIG. 4B illustrates aspects of brace end fittings FIG. 5 illustrates aspects of a brace fitted with reinforcement bars;

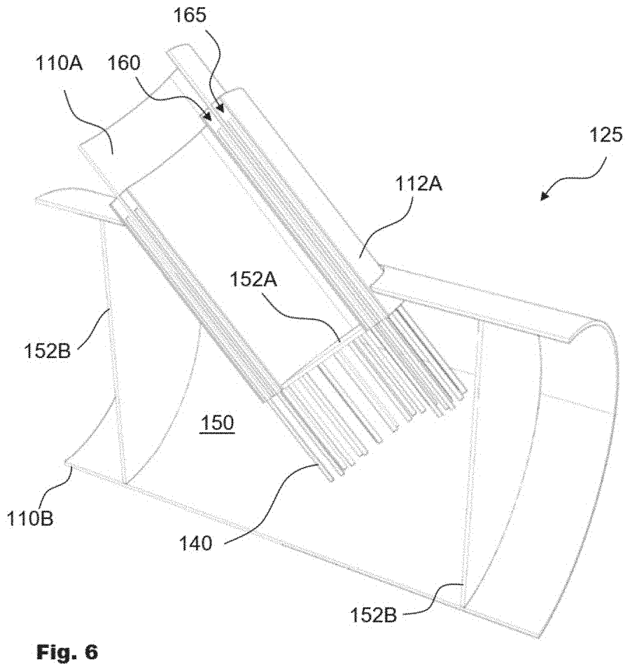

FIG. 6 illustrates further aspects of a brace fitted with reinforcement bars;

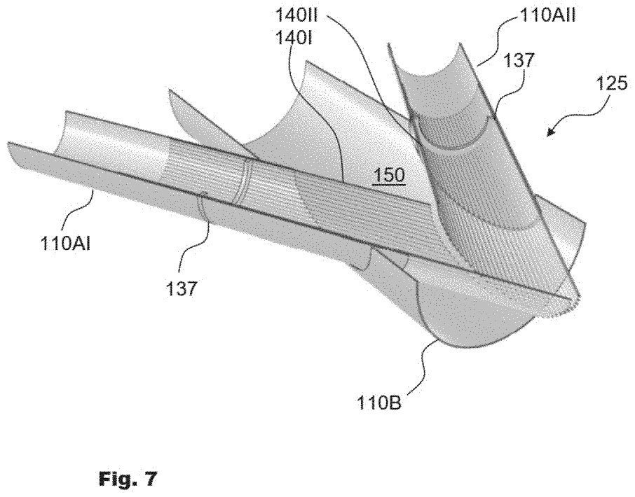

FIG. 7 illustrates a joint with two braces fitted with reinforcement bars;

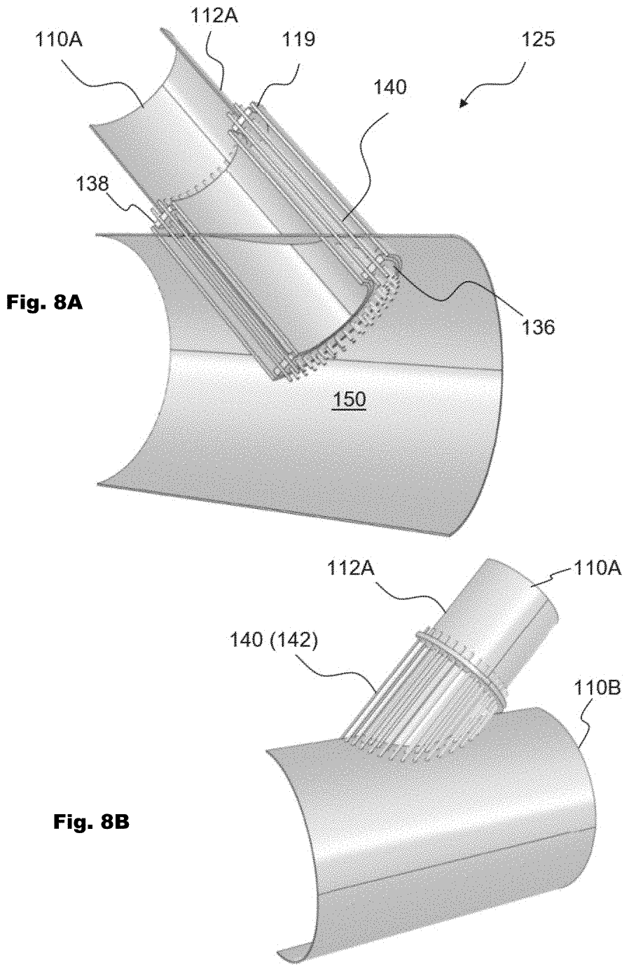

FIG. 8A illustrates further aspects of a brace fitted with reinforcement bars in an open partial view from one side and from another side;

FIG. 8B illustrates further aspects of a brace fitted with reinforcement bars in an open partial view from one side and from another side;

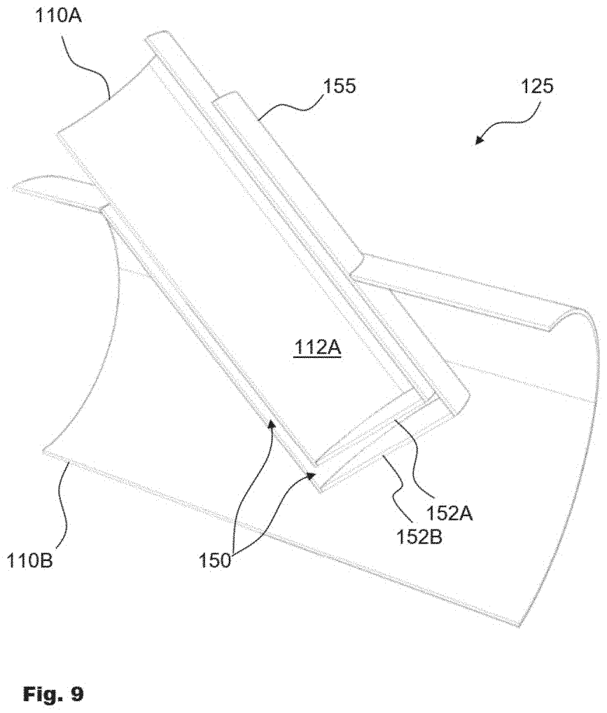

FIG. 9 illustrates a coaxial arrangement of a brace end and a receiving volume;

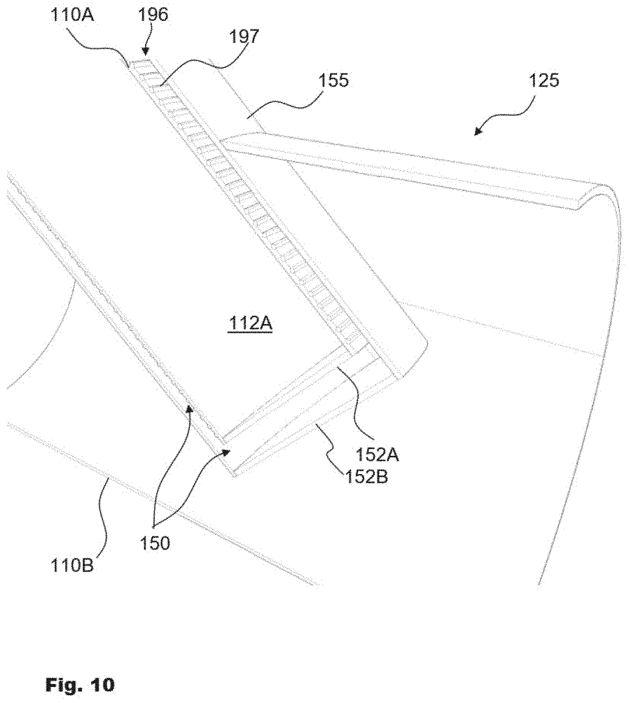

FIG. 10 illustrates a section with shear keys;

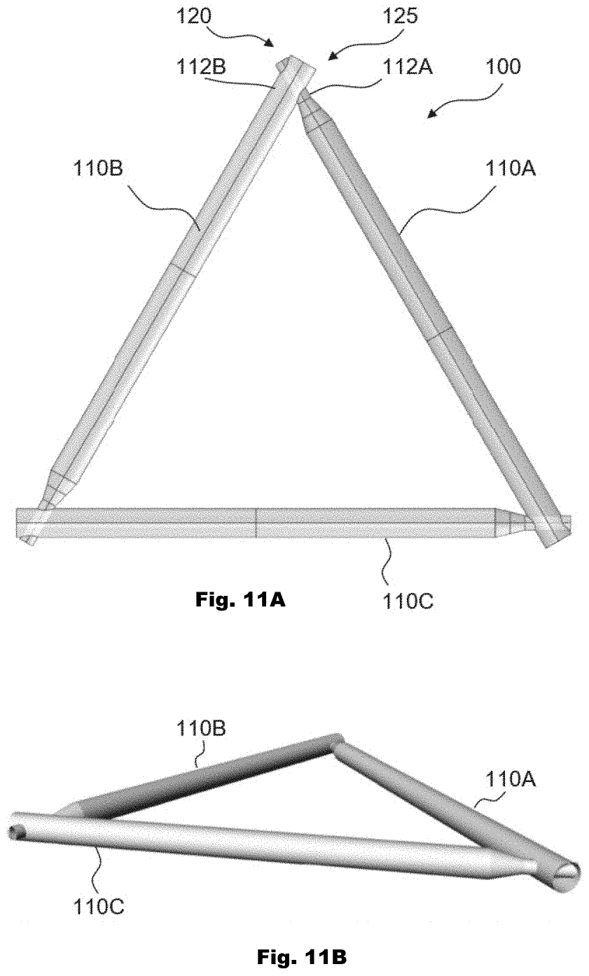

FIG. 11A illustrates a keel structure with grouted joints formed by a thin end-part of one brace inserted into a thick end-part of another brace in top view and perspective view;

FIG. 11B illustrates a keel structure with grouted joints formed by a thin end-part of one brace inserted into a thick end-part of another brace in top view and perspective view;

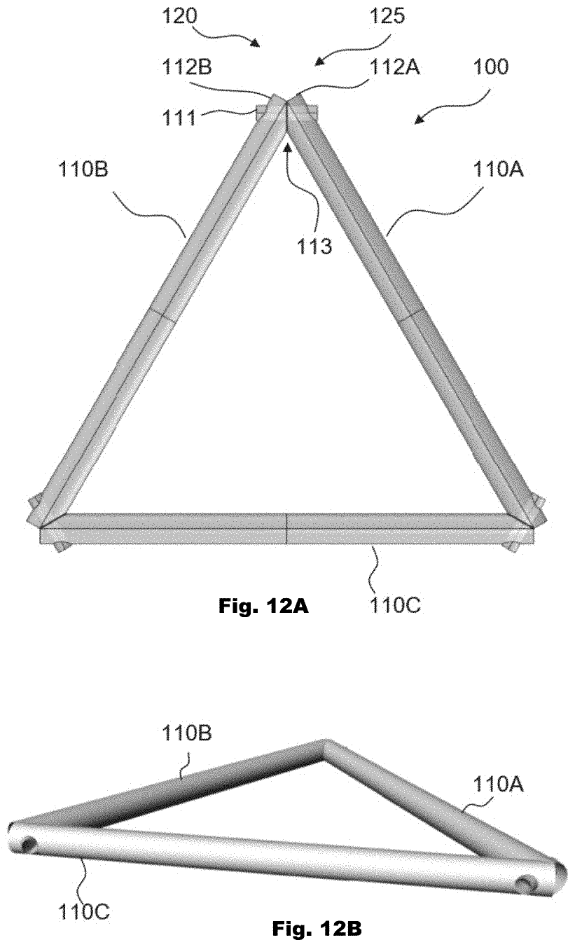

FIG. 12A illustrates a keel structure with grouted joints formed by a joint pipe inserted into complimentary brace ends in top view and perspective view;

FIG. 12B illustrates a keel structure with grouted joints formed by a joint pipe inserted into complimentary brace ends in top view and perspective view;

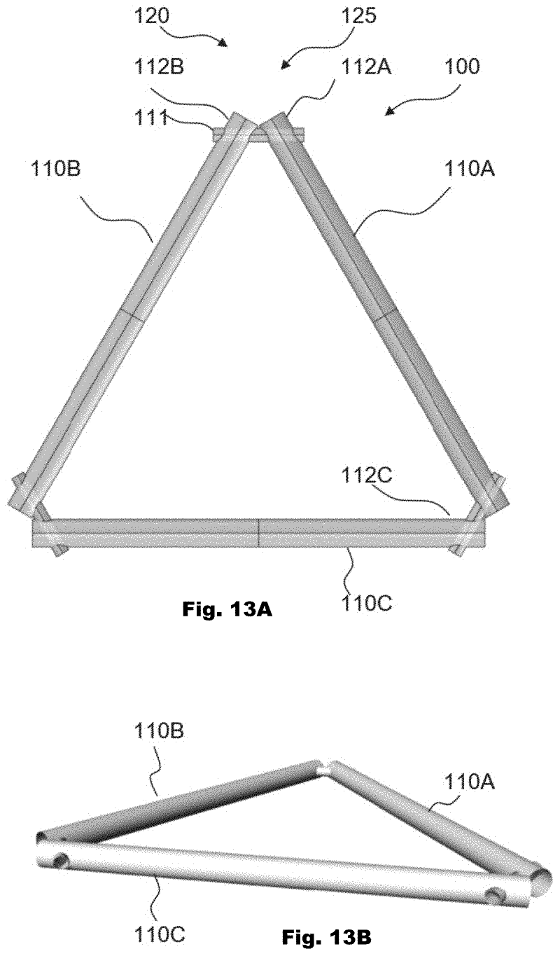

FIG. 13A illustrates a keel structure with grouted joints formed by a joint pipe inserted into brace ends in top view and perspective view;

FIG. 13B illustrates a keel structure with grouted joints formed by a joint pipe inserted into brace ends in top view and perspective view;

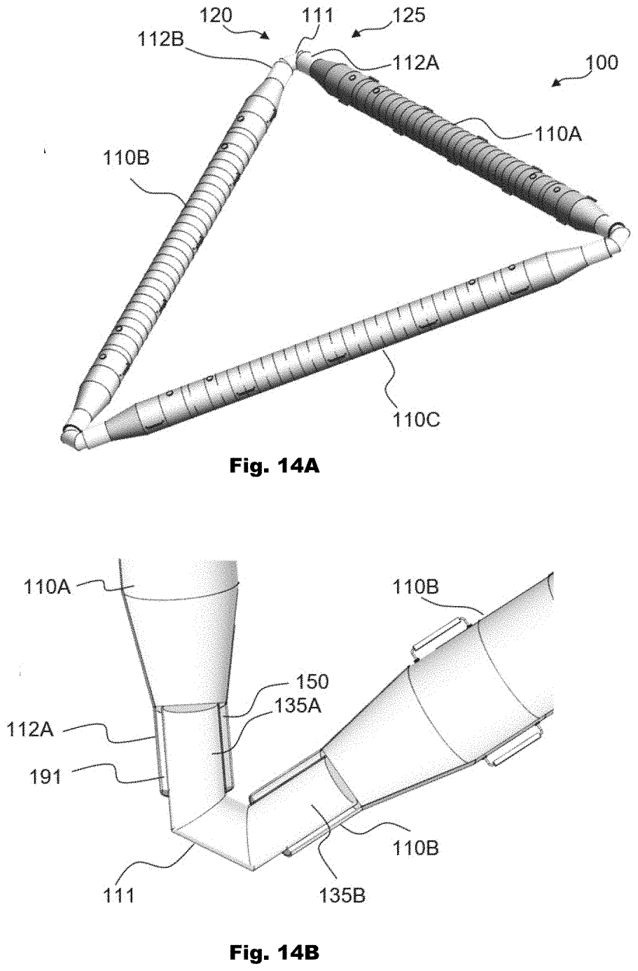

FIG. 14A illustrates a keel structure with grouted joints formed by a bent joint pipe inserted into the very end of braces in perspective view and enlarged partial view; and

FIG. 14B illustrates a keel structure with grouted joints formed by a bent joint pipe inserted into the very end of braces in perspective view and enlarged partial view.

### LIST OF REFERENCE NUMBERS

Item No
100 Structure
105 Support column
110 Brace
111 Joint member
112 Brace end/end-part of brace
113 Abutting edges of complimentary end parts
115 Thin end-part of brace/male part
116 Thick end-part of brace/female part
117 Through part
118 Inner tube
119 Outer tube
120 Node
125 Joint
130 Joint pipe
132 Bent joint pipe or joint member
135 Joint end
136 Flange
137 L-Flange
138 T-Flange
140 Reinforcement bars
142 Bolts
150 Receiving joint volume
152 Separator
155 Tubular section
160 Pre-cast bushing
165 Pre-cast sleeve
190 Concrete
191 Grouting cement
192 Reinforced concrete
195 Grouted joint
196 Concrete section
197 Sheer keys
200 Offshore structure
300 Keel Structure

### DETAILED DESCRIPTION

FIG. 1 illustrates a structure 100 comprising tubular braces 110A, 110B joined at nodes 120 by a joint 125. The braces are straight, tubular braces 110A, 110B and made of steel. The structure 100 is illustrated as a supporting structure with feet at respective nodes 120. A support member 105 is provided on the support structure 100, for example for supporting a wind turbine.

As explained in more detail below, the joint 125 is formed by casted material, for example concrete or grout, in a receiving joint volume in one or both of the braces 110A, 110B.

FIG. 2 illustrates a brace 110A inserted into a receiving volume 150 of another brace 110B. The receiving volume 150 is filled with the casting material, for example concrete or grout. In this case, the receiving volume 150 is defined by the tubular shape of the brace 110B and the separators 152, which are divider walls or plates. The separators 152 may be located according to the actual need of structural strength and/or weight. Here, the joint 125 comprises an end-part 112A of the brace 110A inserted into the receiving joint volume 150 of the other brace 110B. For high connection strength, not only the receiving volume 150 but also the end part 112A is filled with the casted concrete or grout up to the separator 152A of the end part 112A. For additional strength, a laterally inwards and outwards extending end-flange 138, forming a cross sectional shape of the letter “T”, is provided at the very end of the end part 112A. The flange 138 could have other shapes, as also explained below.

FIG. 3 illustrates an angled joint member 110 inserted into receiving volumes 150A, 150B of respective braces 110A, 110B. The joint 125 is formed of end parts 112A, 112B of respective two braces 110A, 110B, each end part 112A, 112B configured with a receiving joint volume 150A, 150B inside which a joint member 111 is received. The volumes 150A, 150B between the end parts 112A, 112B and the joint member 111 are filled with a casting material, such as polymer, grout, or concrete. The joint member 111 is V-shaped and angled according to the angle required for insertion of the two joint ends 135A, 135B coaxially into the end parts 112A, 112B of the respective braces 110A, 110B.

FIGS. 4A and B illustrate aspects of joints 125 end fittings. The end-part 112A of the brace 110A that is inserted into a receiving joint volume 150 in another brace 110B is fitted with a laterally inwards or outwards extending end flange, forming an L-flange, 137 (FIG. 4A) or with a laterally inwards and outwards extending end flange, forming a T-flange 138 (FIG. 4B). The end-part 112A of the inserted brace 110A is hollow and with an opening at the very end so that the hollow end part 112A forms a further volume to be filled with concrete together with the receiving volume 150 of the other brace 110B.

FIG. 5 illustrates aspects of a brace 110A, the end-part 112A has an end flange 138 fitted with reinforcement bars 140 for forming a reinforced concrete joint. The end-part 112A of the brace 110A that is inserted into a receiving joint volume 150 in the other brace 110B is surrounded by multiple reinforcement bars 140 that extend into the receiving volume 150. Whereas the end flange 138 increases the stability of the joint 125 in the axial direction, the bars 140 increase the stability in the rotational direction about the central axis of the brace 110A. As illustrated, the multiple reinforcement bars 140 projects further into the receiving joint volume 150 in the other brace 110B than the end-part 112A of the inserted brace 110A.

FIG. 6 illustrates further aspects of a brace 110A fitted with reinforcement bars 140.

Here, the end-part 112A of the brace 110A that is inserted into the receiving joint volume 150 in another brace 110B is internally and externally for part of its length fitted with a pre-cast bushing 160 and sleeve 165 comprising reinforced concrete. Here, the end-part 112A of the inserted brace 110A has a separator 152A at the very end of the brace 110A so that the casting material is not entering the end part 112A.

FIG. 7 illustrates a joint 125 with two braces 110AI, 110AII each fitted with respective reinforcement bars 1401, 14011 extending into a receiving volume 150 of a receiving brace 110B. The reinforcement bars 1401, 14011 are fitted in respective flanges 137 internally in the braces 110AI, 110AII The reinforcement bars 1401, 14011 are adjusted according to the needed geometry, for example for symmetrical forces.

FIG. 8 illustrates further aspects of a brace 110A fitted with reinforcement bars 140 in what might be considered a hybrid version of a grouted joint 125. In this case, an inner tube 118 and an outer tube 119 are arranged and fixed to the receiving brace 110B, which has a thicker wall material than the brace 110A that is inserted in between the inner tube 118 and the outer tube 119. Reinforcement bars 140 are provided at an angle in parallel to the tubes 118, 119. The thinner brace 110A to be inserted is fitted with a flange 138 and there is a co-operating flange 136 in the receiving volume 150. The reinforcement bars 140 and one or both of the flanges 136, 138 may be fixed or adjusted by bolts and nut connections where the bolts constitute the reinforcement bars 140.

FIG. 9 illustrates a coaxial arrangement of a brace 110A end part 112A inserted into a receiving volume 150 formed in a receiving brace 110B. The receiving joint volume 150 is formed by a tubular section 155, e.g., formed by steel or concrete, that functions as a sleeve and is generally coaxial with the end-part 112A of the brace 110A that is inserted into the receiving joint volume 150 in the receiving tubular section 155 of the receiving brace 110B.

In continuation of FIG. 9, FIG. 10 illustrates a concrete section 196 with shear keys 197. The end-part 112A that is inside the tubular section 155 is fitted with shear keys 197.

FIGS. 11, 12, 13 and 14 illustrate a structure 100 comprising three braces 110A, 110B, and 110C that are numbered according to being joined at respective nodes 120 by joints 125. The joints 125 are formed by casted concrete or grout (not shown) in respective receiving joint volumes in the braces 110A, 110B, 110C as explained above.

For example, such structure 100 is intended to be a keel structure for a floating off-shore structure and to have negative buoyancy. Alternatively, or additionally, such structure principle is used as part of a floating frame, optionally with such keel structure.

The form of the structure is a triangle. The structure is here formed by identical braces 100 and identical joints 125 at respective nodes 120.

FIG. 11A illustrates, a top view and FIG. 11B a perspective view of a structure 100 with braces 110A, 110B, 110C joined at nodes 120 as grouted joints 125 formed by a narrow end-part 112A of a first brace 110A inserted into a thicker end-part 112B of another brace 110B. This system relates also to the principles explained in FIGS. 2, 4-6, and 8-10.

FIG. 12 and FIG. 13 illustrate structures 100 with a joint 125 formed of a joint member 111 at brace end-parts 112A, 112B of respective two braces 110A, 110B at each node 120 and each end-part 112A, 112B configured with a receiving joint volume. In this case, the end part 112A, 112B of two adjacent braces at a node 120 are configured to receive a joint member 111, such as a joint pipe 130, and the receiving joint volumes 150A, 150B are filled with concrete 190.

FIG. 12 specifically illustrates nodes 120 where the respective brace end-parts 112A, 112B are formed complementary to interface along edges 13 against each other and a joint member 111, such as a joint pipe 130, is inserted laterally to the end-parts 112A, 112B and joined by casting, for example grouting, as outlined above. The casted, for example grouted, joints 125 are formed by a joint member 111 inserted laterally into the complimentary brace end part 112A, 112B. As the triangle is an equilateral triangle, the joint member 111 has an angle of 60 degrees with the braces adjacent 110.

FIG. 13 specifically illustrates three nodes 120 in a triangular structure with casted, for example grouted, joints formed by a joint member 111, such as a joint pipe 130, inserted laterally into the brace end parts 112A, 112B of two braces 110A, 110B at each node 120. As the triangle is an equilateral triangle, the joint member 111 has an angle of 60 degrees with the braces adjacent 110.

FIG. 14 illustrates a structure with joints 125 formed at respective nodes 120 and formed by an angled joint member 111, such as a joint pipe 130, inserted into the end parts 112A, 112B of the braces 110A, 110B. The joint member 111 is angled and provided with joint ends 135A, 135B that are inserted coaxially into the end parts 112A, 112B, where a casting material, such as grout 190, is provided in the receiving joint volumes 150 between the outer wall of the joint ends 135A, 135B and the inner wall of the end parts 112A, 112B at the narrowing ends of the respective braces 110A, 110B, as illustrated. The angled join member 111, such as joint pipe, is shown largely as a “V-shaped” joint member 111 corresponding to the triangular shape of the structure 100. The joint member 111 is shaped as piecewise linear. The shape is similar to a boomerang shape.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. An offshore structure (100) comprising at least two tubular braces (110A, 110B) with end parts (112A, 112B) of the braces (110A, 110B) joined by a joint (125) at a node (120) of the structure, wherein the tubular braces (110A, 110B) are optionally made of steel, and wherein the joint (125) is formed by means of hardened casting material, for example concrete or grout, in a receiving joint volume (150) in one or both end parts (112A, 112B) of the braces (110A, 110B) that form the node (120).

2. Structure according to claim 1, wherein the node (120) comprises a joint member (111) different from the braces (110A, 110B), and wherein each end part (112A, 112B) has a receiving joint volume (150A, 150B) inside which a respective section of the joint member (111) is received for connecting the end parts (112A, 112B) of the braces (110A, 110B) at the node (120) by the joint member (111), and wherein the volumes (150A, 150B) between the joint member (111) and the respective end parts (112A, 112B) are filled with the casting material, for example concrete or grout.

3. Structure (100) according to claim 2, wherein the joint member (111) has two joint ends (135A, 135B) and is angled according to the angle required for insertion of the two joint ends (135A, 135B) into the end parts (112A, 112B) of the braces (110A, 110B) at the respective node (120).

4. Structure (100) according to claim 3, wherein each joint ends (135A, 135B) that are inside the end parts (112A, 112B) are coaxial with the respective end part (112A, 112B).

5. Structure (100) according to claim 3 or 4, wherein the joint member is piecewise linear angled with the two linear joint ends (135A, 135B) having an angle in between which is fitting the angle between the end parts (112A, 112B).

6. Structure (100) according to claim 2, wherein the joint member (111) is straight and extends laterally through the end parts (112A, 112B) at the node (120) and wherein the cast material is provided between an outer side of the joint member (111) and an inner side of the end parts (112A, 112B).

7. Structure according to any one of the claims 2-6, wherein the structure (100) comprises at least three tubular braces (110A, 110B) arranged as a polygon with end parts (112A, 112B) of the braces (110A, 110B) joined at the node (120) and at further nodes of the polygon by the joint member (111).

8. Structure (100) according to claim 7, wherein the polygon is an equilateral triangle with three braces (110A, 110B, 110C) forming the triangle, the three braces being joined by the joint member (111) pairwise at the nodes (120).

9. Structure (100) according to claim 2, wherein the structure (100) comprises three tubular braces (110A, 110B, 110C) arranged as an equilateral triangle with end parts (112A, 112B, 112C) of the braces (110A, 110B, 110C) joined pairwise by the joints (125) at the node (120) and at two further nodes, wherein the joint member (111) is straight and extends laterally through two adjacent end parts (112A, 112B) of a pair of braces (110A, 110B) at the node (120), wherein a central axis of the joint member (111) has an angle of 60 degrees with the central axes of each of the two braces (110A, 110B) at the node (120), wherein the cast material is provided between an outer side of the joint member (111) and an inner side of the end parts (112A, 112B).

10. Structure (100) according to claim 9, wherein adjacent end-parts (112A, 112B) at the node (120) are formed complementary and abutting each other along an edge region (113), and wherein the straight joint member (111) is inserted into the abutting complimentary brace end parts (112A, 112B) and joined to the brace end-parts (112A, 112B) by the casting material.

11. The structure (1) according to any one of the claims 2-10, wherein the joint member (111A) is internally and/or externally for part of its length fitted with shear keys (197) in the receiving joint volume (150A, 150B) in the end part (112A, 112B).

12. The structure (1) according to any one of the preceding claims, wherein the casting material comprises cement.

13. The structure according to any one of the preceding claims, wherein the structure is a floating offshore structure.

14. The structure according to any one of the preceding claims, in combination with an offshore wind turbine, wherein the wind turbine is supported by the structure.

15. Use of a structure according to any one of the preceding claims for supporting an offshore wind turbine.
